(19) United States
(12) Patent Application Publication
(10) Pub. No.: US 2007/0182217 A1
(43) Pub. Date: Aug. 9, 2007

(54) TRANSPARENT VEHICLE ROOF

(75) Inventors: Steven Saleen, Coto De Caza, CA (US); William Tally, Dove Canyon, CA (US)

Correspondence Address: PAUL, HASTINGS, JANOFSKY & WALKER LLP, P.O. BOX 919092, SAN DIEGO, CA, 92191-9092, US

(73) Assignee: Saleen, Inc., Irvine, CA (US)

(21) Appl. No.: 11/463,864

(22) Filed: Aug. 10, 2006

Related U.S. Application Data
(60) Provisional application No. 60/707,762, filed on Aug. 12, 2005.

(51) Int. Cl. B60J 7/00

(52) U.S. Cl. 296/215

(57) ABSTRACT

The invention is related to a transparent roof system for an automobile which affords panoramic viewing of the surrounding for all passengers in the cabin of the vehicle. The roof system includes a transparent roof panel which extends between the front and rear windshields of an automotive vehicle thereby forming a glass-to-glass connection between the front windshield and the rear windshield. With such an arrangement, substantially the entire upper surface of the vehicle body is transparent and provides an increased upward viewing area of the outside environment to passengers in the vehicle. The substantially contiguous arrangement of the front windshield, the transparent roof and the rear windshield provides passengers with an upward viewing area of approximately 180 degrees.

### CROSS-REFERENCE TO RELATED APPLICATION

The present application is related to U.S. Provisional application Ser. No. 60/707,762 filed Aug. 12, 2005 and U.S. Design patent application Ser. No. 29/236,247 filed Aug. 12, 2005 by the same inventive entity and entitled the same.

### FIELD OF THE INVENTION

The present invention relates to a transparent roof for a vehicle. More specifically, the invention relates to a transparent roof panel which spans from the top of the front windshield to the top of the rear windshield, and provides a glass to glass appearance from the cowl to the trunk of the vehicle.

### BACKGROUND OF THE INVENTION

One of the pleasures of travel by motor vehicle is viewing the surroundings which one travels through. A panoramic view which includes upward viewing would be most desirable. At present, only a convertible vehicle can afford such a panoramic view. However, convertible vehicles also expose the vehicle's occupants to a noisier ride and subject them constantly to the elements of the environment. Conventional vehicles with an enclosed cabin design limit the panoramic view as most of the roof panels are formed of the same non-transparent materials as the rest of the vehicle body, typically of sheet metal. Such opaque roofs limit upward viewing from the passenger cabin.

The viewing pleasure improves with vehicles that include a sun-roof or moon-roof, as shown in FIG. 1, in which an opening 2 is formed in the roof R for accommodating a glass panel 3 that can typically be selectively opened and closed. However, the sun-roofs or moon-roofs generally cover only a small section of the roof and are very limiting for upward viewing; particularly for the backseat passengers. In addition, these sun or moon roofs generally are flat panels and do not conform precisely to the curvature of the roof line; thus they negatively affect the aerodynamic and style of the vehicle and they often reduce interior headroom as well.

It may be appreciated that there is a need for a new vehicle roof design which allows panoramic viewing of the surrounding by all occupants in the vehicle and which preserves the generally smooth and aerodynamic lines of the roof of the vehicle.

### SUMMARY OF THE INVENTION

The invention is related to a transparent roof system for an automobile which affords panoramic viewing of the surroundings for all passengers in the cabin of the vehicle.

In one embodiment, the invention is related to a transparent vehicle roof for an automotive vehicle having front and rear windshields, which comprises a transparent roof panel having a periphery comprising front, rear and side edges. The front edge of the transparent roof panel is positioned adjacent to the front windshield of the vehicle; and the rear edge of the roof panel is positioned adjacent to the rear windshield of the vehicle, and the roof panel is supported entirely about its periphery by internal support elements of the vehicle. Generally, the transparent roof panel possesses a curved shape which provides aerodynamic properties to the vehicle.

With the arrangement stated above, the transparent vehicle roof provides a glass-to-glass connection between the front windshield and the rear windshield such that the support elements are not visible, other than through the transparent glass panels. The junctions which are formed between the roof panel and the front and rear windshields are typically less than about 15 mm in width, more typically between about 2 mm to about 10 mm in width, even more typically about 5 mm in width. With such an arrangement, substantially the entire upper surface of the vehicle's passenger compartment is transparent and the passengers are provided with an upward viewing area of approximately 180 degrees.

The transparent roof panel is typically made of a transparent laminate, more typically of a glass laminate. The roof panel may be of any thickness; typically it is about 6 mm thick. Additionally, the roof panel may include a layer of electrochromatic material.

Another embodiment of the invention is related to an automotive vehicle top having a transparent roof extending between a front windshield and a rear windshield, which includes a front windshield and a rear windshield, a transparent roof panel having a periphery comprising front, rear and side edges. The front edge of the transparent roof panel is placed adjacent to the front windshield of the vehicle and the rear edge of the transparent roof panel is placed adjacent to the rear windshield of the vehicle, such that the transparent roof panel provides a glass-to-glass connection between the front windshield and the rear windshield and the junctions between the roof panel and the front and the rear windshields are less that about 15 mm in width. Generally, there is no supporting elements of the vehicle exists between the transparent roof panel and the front and rear windshields. The transparent roof panel is typically made of a laminate of transparent material. More typically, the laminate is a glass laminate of approximately 6 mm thick. In some embodiment, the laminate may include a layer of electrochromatic material.

The third embodiment of the invention is related to a roof system for an automobile which includes a transparent front windshield panel, a transparent rear windshield panel, and two transparent roof panels. The roof panels extend between the front windshield panel and the rear windshield panel, where a front edge of each of the roof panels lie substantially contiguously along a top edge of the front windshield panel, and a rear edge of each of the roof panels lie substantially contiguously along a top edge of the rear windshield thereby forming a glass-to-glass connection between the front windshield and the rear windshield. With such an arrangement, the roof panels are surrounded at their periphery by the front windshield, the rear windshield, a left side rail, a right side rail and a center rail of the vehicle. Generally, the transparent roof panels possess curved shape providing aerodynamic properties to the vehicle.

### BRIEF DESCRIPTION OF THE DRAWINGS

FIG. 1 a perspective view of a roof of a vehicle roof having a sunroof;

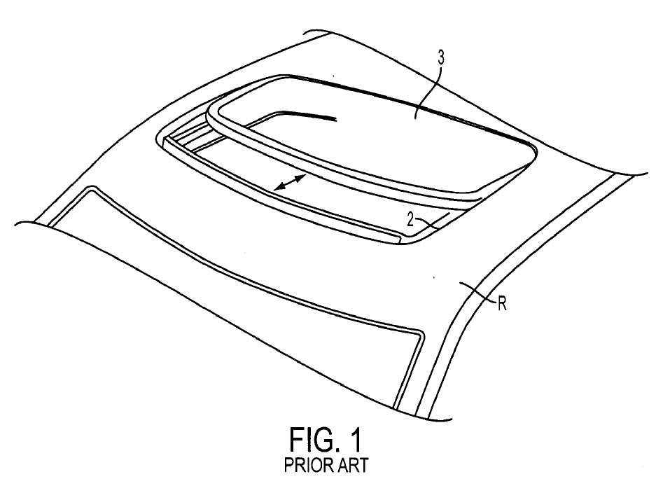

FIG. 2 is a top elevation view of a vehicle roof showing one embodiment of the glass-to-glass roof system of the invention;

FIG. 3 is a side elevation view of a vehicle showing one embodiment of the glass-to-glass roof system of the invention;

FIG. 4 is a left rear perspective view of a vehicle showing one embodiment of the glass-to-glass roof system of the invention;

FIG. 5 is a top elevation view of a vehicle roof showing a second embodiment of the glass-to-glass roof system of the invention;

FIG. 6 is a left rear perspective view of a vehicle roof after the original roof was removed showing the internal structural support elements for the roof panel of the invention;

FIG. 7 is a top elevation view of a vehicle roof after the original roof was removed showing the internal structural support elements for the roof and of the invention;

FIG. 8 is a cross sectional view of one embodiment of the roof system taken along line 8-8 in FIG. 2 showing the relationship of the seal with the side rail, the roof panel, and the side support element.

### DETAILED DESCRIPTION OF THE PREFERRED EMBODIMENTS

For the purposes of promoting an understanding of the principles of the invention, references will now be made to the embodiments illustrated in the drawings and specific language will be used to describe the same. It should be understood that no limitation of the scope of the invention is thereby intended; such alterations and further modifications in the illustrated device, and such further applications of the principles of the invention as illustrated therein being contemplated as would normally occur to one skilled in the art to which the invention relates are included.

The invention is related to a transparent roof system for an automobile which affords panoramic viewing of the surroundings for all passengers in the cabin of the vehicle. In providing this expansive viewing, the invention provides a glass-to-glass roof system which conforms to the original roof lines of the vehicle and eliminates most interruptions which negatively impact the aerodynamic lines of the vehicle. The term “glass-to-glass” refers to the substantially contiguous arrangement of the front windshield, the roof panel and the rear windshield. The term “glass” as used in the term “glass-to-glass” and in this application intends to cover conventional glass materials including laminates, coated and uncoated glass panels, and also all transparent glass like materials that are suitable for use as vehicle roof panels.

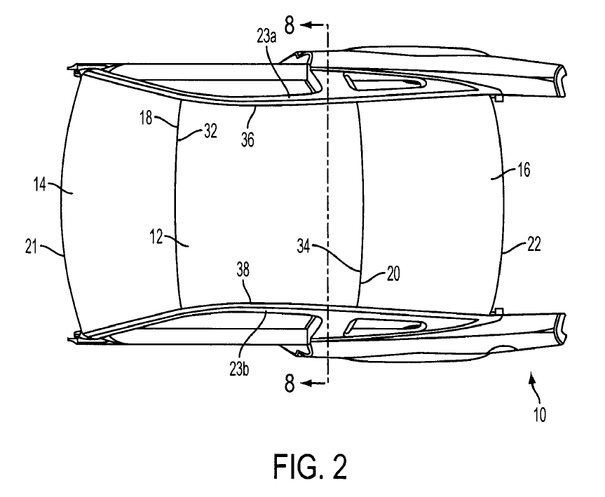

Referring to FIG. 2 which shows the top elevation view of a vehicle 10, the roof panel 12 which comprises a panel of substantially transparent material, such as a glass laminate or other similar material known to those skilled in the art of the automotive industry for use in windows, windshields, sunroofs, moonroofs and the like. In some embodiments, the roof panel 12 comprises a 6 mm thick glass laminate, though it may also be of different thicknesses as needed for rigidity or safety, and may vary in thickness, i.e. it need not necessarily be of uniform thickness. The roof panel 12 may optionally comprise a laminate having an electrochromatic or photochromic layer. In other alternative embodiments, at least an outer surface of the roof 12 may include tinting or a layer of reflective material to reduce the amount of direct sunlight that enters through the transparent roof 12 into the passenger area of the vehicle 10.

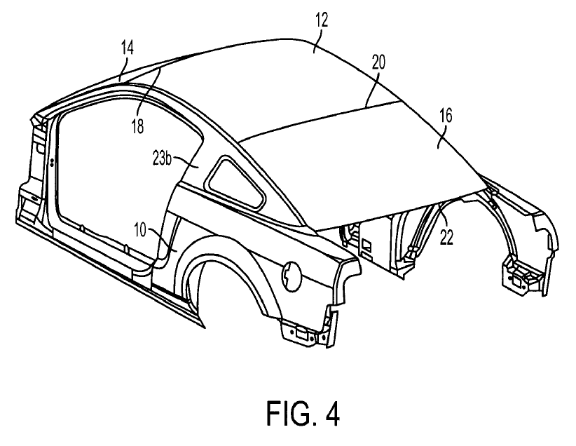

Referring now to FIGS. 2-4, which show various views of one embodiment of the transparent glass-to-glass roof system of the invention. The roof system comprises a front windshield panel 14, a transparent roof panel 12 and a rear windshield panel 16. The figures show that the transparent roof panel 12 extends between the front windshield panel 14 and rear windshield panel 16 forming a junction 18 between the top of front windshield 14 and the front edge 32 of roof panel 12 and a junction 20 between the top of rear windshield 16 and the rear edge 34 of roof panel 12. Junctions 18 and 20 are quite narrow, generally not exceeding about 15 mm in width. In some embodiments, junctions 18 and 20 are between about 2 mm to about 10 mm in width. In some other embodiments, junctions 18 and 20 are about 5 mm in width. Generally, junctions 18 and 20 between the two glass panels are not filled. However, in some embodiments, junctions 18 and 20 may be filled with a caulking or padding material; and in other embodiments, junctions 18 and 20 may have a non-structural material, e.g. decorative trim pieces, inserted therein.

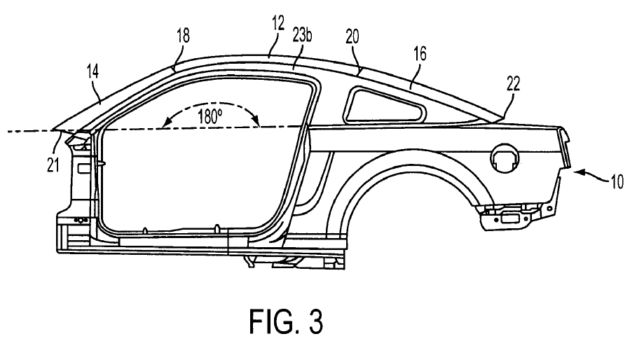

By utilizing a transparent roof panel 12, and with the roof panel 12 arranged in a “glass-to-glass” arrangement between the front windshield 14 and the rear windshield 16, substantially the entire upper surface of the passenger compartment of the vehicle 10 is transparent. Such a “glass-to-glass” appearance provides an increased upward viewing area of the outside environment to passengers in the vehicle. As shown in FIG. 3, the substantially contiguous arrangement of the front windshield 14, the transparent roof panel 12 and the rear windshield 16 provides the passengers in the vehicle with an upward viewing arc of approximately 180 degrees.

Referring again to FIG. 3, it further shows an embodiment of the invention in which roof panel 12 is curved. The curvature of roof panel 12 aligns with front windshield 14 and rear windshield 16 such that the upper surface of the roof panel 12 is preferably situated to be flush with the respective upper surfaces of the front and rear windshields 14 and 16, to provide a smooth, aerodynamic outer contour for the roof of vehicle 10. In alternative embodiments, the roof panel 12 may be situated in a non-flush manner with respect to the front and rear windshields 14, 16 in order to accommodate other design alternatives. The transparent roof panel 12 is thus preferably formed to possess an aerodynamic curved shape that follows the outer contours of the vehicle 10.

FIGS. 2 to 4 show one embodiment of the roof system of the invention which features no support elements that are visible from the exterior from the bottom edge of the front windshield 21 (cowl) to the bottom edge of the rear windshield 22 (trunk line) except for support elements that may be viewed through the transparent components of the roof system. It is designed so that the transparent roof panel 12 is supported about its periphery to maintain an increased viewing area and to allow the transparent roof 12 to possess a desired aerodynamic curved shape. The roof panel 12 is designed to be supported from the underside such that supporting elements would not be visible from the outside to detract from the aesthetically pleasing, uniform, smooth surfaces from the cowl 21 to the trunk line 22, except where they may be visible through the glass panel and/or windshields of the roof system.

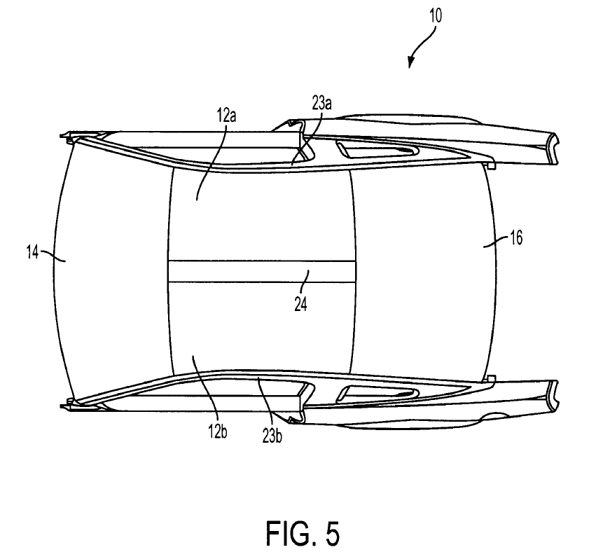

In other embodiments, the roof system may include supports that run from the top of front windshield 14 to the top of back windshield 16. Depending on the type of support of the vehicle, the roof panel may be a single panel which spans the distance between the front and rear windshield and be supported from the under side at its periphery and at the center. Referring to FIG. 5, which shows another embodiment of the invention where the roof panel 12 may be a split panel 12a, each portion of which is surrounded at its periphery by the side rails 23a and 23b, and center support 24.

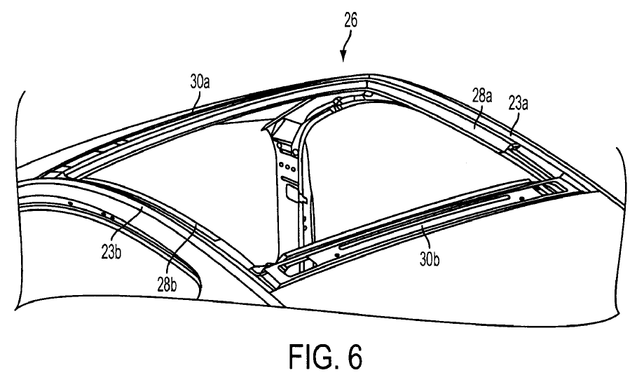

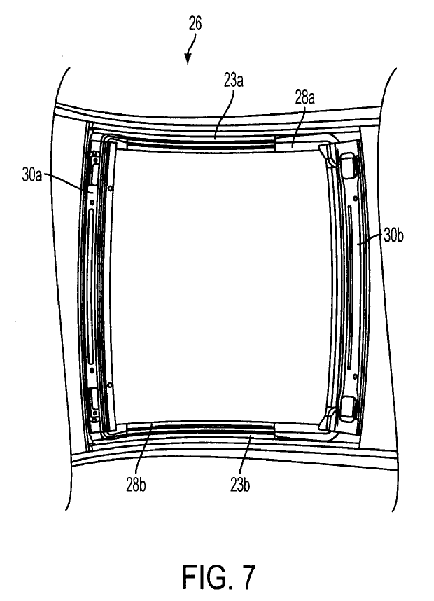

The transparent roof 12 essentially replaces the outer ‘skin’ or metallic layer of the rooftop of the vehicle 10 with a panel of transparent material. FIGS. 6 and 7 show the internal roof support elements (or structure) 26 of a vehicle 10 after the original metallic roof has been removed. The internal support structure 26 includes right side support element 28a, left side support element 28b, front support element 30a and rear support element 30b. The roof panel 12 includes a front edge 32 and a rear edge 34, right side edge 36 and left side edge 38. Roof panel 12 is sized to fit on and within the boundaries of internal roof support structure 26 having front edge 32 and rear edge 34 supported respectively by front support element 30a and rear support element 30b, and having right side edge 36 and left side edge 38 respectively supported by right side support element 28a and left side support element 28b. In this manner, the circumference of the roof panel 12 is essentially surrounded by the front and rear windshields 14, 16 and the upper side rails 23a, 23b. The roof panel 12 may alternatively or additionally be supported by support rails that extend between the front and rear support elements 30a and 30b and the right and left support elements 28a and 28b.

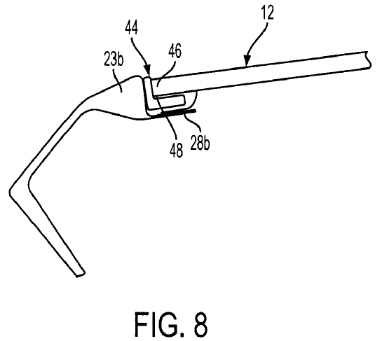

Referring to FIG. 8, a trim seal 44 is provided between glass panel 10, side rail 23b (FIG. 3) and side rail support 42b (FIGS. 6 and 7). In addition to sealing the cabin from the outside environment, trim seal 44 may also function as a shock absorber to protect the glass components of the roof system. In the illustrated embodiment, trim seal 44 is an L-shaped unitary structure which extends along the right and left side rails 23a and 23b of vehicle 10. The trim seal may take many different forms, as long as the side edge 46 and bottom edge 48 of roof panel 12 are protected. For example, two separate seals may be used, one being placed along the side edge 46 and one being placed along the bottom edge 48 of roof panel 12. Trim seal 44 may be attached to side rails 23a and 23b, and side support elements 28a and 28b by adhesive or by any other attachment means such as screws, rivets or similar mechanical fasteners, and by other means known in the art. Trim seal 44 is generally made of a flexible material that is sufficiently hard to provide protection to the edge 46 and 48 of roof panel 12 but adequately compliant to absorb some movement when the vehicle body flexes. Suitable materials for the trim seal include, but are not limited to buna, urethane, viton and silcone.

The different structures of the transparent vehicle roofs of the present invention are described separately in each of the above embodiments. However, it is the full intention of the inventors of the present invention that the separate aspects of each embodiment described herein may be combined with the other aspects and features described herein. Those skilled in the art will appreciate that various adaptations and modifications of the just described preferred embodiments can be employed without departing from the scope and spirit of the invention. Therefore, it is to be understood that, within the scope of the appended claims, the invention may be practiced other than as specifically described herein.

What is claimed:

1. A transparent vehicle roof for an automotive vehicle having front and rear windshields, comprising:
a transparent roof panel having a periphery comprising front, rear and side edges;
said front edge of said transparent roof panel being positionable adjacent to the front windshield of the vehicle; and
said rear edge of said transparent roof panel being positionable adjacent to the rear windshield of the vehicle.

2. The transparent vehicle roof of claim 1, wherein said transparent roof panel provides a glass-to-glass connection between the front windshield and the rear windshield, and wherein no support elements are visible exterior of said vehicle.

3. The transparent vehicle roof of claim 1, wherein a junction between said roof panel and said front windshield and a junction between said roof panel and said rear windshield are less than about 15 mm in width.

4. The transparent vehicle roof of claim 3, wherein said junctions are between about 2 mm to about 10 mm in width.

5. The transparent vehicle roof of claim 1, wherein said transparent roof panel comprises a laminate of transparent material.

6. The transparent vehicle roof of claim 5, wherein said transparent roof panel comprises a glass laminate.

7. The transparent vehicle roof of claim 6, wherein said glass laminate is approximately 6 mm thick.

8. The transparent vehicle roof of claim 5, wherein said transparent roof panel includes a layer of electrochromatic material.

9. The transparent vehicle roof of claim 1, wherein said transparent roof panel is supported entirely about its periphery by internal support elements of said vehicle.

10. The transparent vehicle roof of claim 1, wherein said transparent roof panel possesses a curved shape providing aerodynamic properties to the vehicle.

11. An automotive vehicle top having a transparent roof extending between a front windshield and a rear windshield, comprising:
a front windshield and a rear windshield;
a transparent roof panel having a periphery comprising front, rear and side edges;
wherein said front edge of said transparent roof panel is adjacent to the front windshield of the vehicle and said rear edge of said transparent roof panel is adjacent to the rear windshield of the vehicle.

12. The automotive vehicle top of claim 11, wherein said transparent roof panel provides a glass-to-glass connection between the front windshield and the rear windshield, and wherein junctions between said roof panel and said front and said rear windshields are less that about 15 mm in width.

13. The automotive vehicle top of claim 11, wherein no supporting elements of said vehicle exists between said transparent roof panel and said front and rear windshields.

14. The automotive vehicle top of claim 11, wherein said transparent roof panel comprises a laminate of transparent material.

15. The automotive vehicle top of claim 14, wherein said transparent roof panel comprises a glass laminate; wherein said glass laminate is approximately 6 mm thick.

16. The automotive vehicle top of claim 14, wherein said laminate further comprises a layer of electrochromatic material.

17. The automotive vehicle top of claim 11, wherein said transparent roof panel is supported entirely about its periphery by the vehicle.

18. The automotive vehicle top of claim 11, wherein said transparent roof panel possesses a curved shape providing aerodynamic properties to the vehicle.

19. A roof system for an automobile comprising:
a transparent front windshield panel,
a transparent rear windshield panel, and
two transparent roof panels;
wherein said roof panels extend between said front windshield panel and said rear windshield panel, wherein a front edge of each of said roof panels lie substantially contiguously along a top edge of said front windshield panel, and a rear edge of each of said roof panels lie substantially contiguously along a top edge of said rear windshield thereby forming a glass-to-glass connection between said front windshield and said rear windshield; and
wherein said roof panels are surrounded by their periphery by said front windshield, said rear windshield, a left side rail, a right side rail and a center rail of said vehicle.

20. The transparent vehicle roof of claim 19, wherein said transparent roof panels possess curved shape providing aerodynamic properties to said vehicle.
